(19) United States
(12) Patent Application Publication
(10) Pub. No.: US 2023/0374304 A1
(43) Pub. Date: Nov. 23, 2023

(54) THERMOPLASTIC POLYMER COMPOSITION

(71) Applicant: SOLVAY SPECIALTY POLYMERS USA, LLC, Alpharetta, GA (US)

(72) Inventors: Chinomso Nwosu, Alpharetta, GA (US); Vijay Gopalakrishnan, Dunwoody, GA (US)

(73) Assignee: SOLVAY SPECIALTY POLYMERS USA, LLC, Alpharetta, GA (US)

(21) Appl. No.: 17/924,664

(22) PCT Filed: May 10, 2021
(86) PCT No.: PCT/EP2021/062309

§ 371 Date: Nov. 10, 2022

Related U.S. Application Data
(60) Provisional application No. 63/023,349, filed on May 12, 2020.

(30) Foreign Application Priority Data
Jun. 8, 2020 (EP) 20178780.1

(51) Int. Cl. C08L 77/06; C08K 7/06; C08K 7/28; C08K 3/04

(52) U.S. Cl. CPC C08L 77/06; C08K 7/06; C08K 7/28; C08K 3/04; C08K 2201/004; C08L 2203/20; C08L 2205/025; C08K 2201/003

(57) ABSTRACT

The invention pertains to a polymer composition comprising 10-82 wt. % of a thermoplastic polymer, 5-45 wt. % of carbon fibers, and 13-45 wt. % of hollow glass beads. The resulting composition has an improved combination of tensile modulus and tensile strain with respect to known composition.

### CROSS REFERENCE TO RELATED APPLICATIONS

The present application is a U.S. national stage entry under 35 U.S.C. § 371 of International Application No. PCT/EP2021/062309 filed on May 10, 2021, which claims priority to U.S. provisional patent application No. 63/023,349, filed on May 12, 2020, and to European patent application no. 20178780.1, filed on Jun. 8, 2020. The entire contents of these applications are incorporated herein by reference for all purposes.

### TECHNICAL FIELD

The present invention relates to a thermoplastic polymer composition, in particular, to a thermoplastic polymer composition being light-weight and having excellent mechanical performance, and to a method for making said thermoplastic polymer composition. The invention further relates to mobile electronic device components including said thermoplastic polymer composition.

### BACKGROUND ART

Due to their reduced weight, high mechanical performance and great design options, thermoplastic polymer compositions are attractive as metal replacement in mobile electronic device components.

In particular, thermoplastic polymer compositions containing hollow glass beads and reinforcing fibers have been described, however, said compositions generally exhibit either poor mechanical properties (low tensile modulus, low tensile strain) and/or high density.

Need is therefore felt for thermoplastic polymer compositions that effectively addresses the appropriate balance of properties required for the mobile electronics device components, in particular need is felt for thermoplastic polymer compositions which have low density combined with sufficient rigidity (high tensile modulus) and with enough tensile strain to avoid fracturing.

### SUMMARY OF INVENTION

In a first aspect, the present invention relates to a polymer composition [composition (C)] comprising:
10-82% by weight of at least one thermoplastic polymer selected from the group consisting of poly(arylene sulphide) (PAS), poly(aryl ether sulfone) (PAES), poly(aryl ether ketone) (PAEK), polyesters (PE), polyamides (PA), and combinations thereof;
5-45% by weight of carbon fibers; and
13-45% by weight of hollow glass beads;

In another aspect, the present invention relates to a mobile electronic device component comprising the composition (C) as defined above.

Advantageously, the composition (C) according to the invention shows excellent modulus and tensile strain, while having a low density. Thanks to its combination of properties the composition (C) according to the invention can be desirably incorporated into mobile electronic device components.

### DETAILED DESCRIPTION OF THE INVENTION

Described herein is a polymer composition [composition (C)] comprising one or more thermoplastic polymers, carbon fibers, and hollow glass beads. The thermoplastic polymer is selected from the group consisting of poly(arylene sulphides) (PAS), poly(aryl ether sulfones) (PAES), poly(aryl ether ketones) (PAEK), polyesters (PE), polyamides (PA), and combinations thereof.

It was surprisingly found that by incorporating the hollow glass beads and the carbon fibers in the claimed ranges, the resulting composition (C) offered a very good compromise between tensile modulus, tensile strain and low density, especially in relation to both analogous compositions having a different amount of the same components.

More specifically, it was unexpectedly found that the composition (C) according to the invention exhibited significantly higher tensile strain and modulus relative to analogous compositions having the same density and incorporating the same amount of hollow glass beads and a lower amount of carbon fibers.

In the present description, unless otherwise indicated, the following terms are to be meant as follows.

The term “alkyl”, as well as derivative terms such as “alkoxy”, “acyl” and “alkylthio”, as used herein, include within their scope straight chain, branched chain and cyclic moieties. Examples of alkyl groups are methyl, ethyl, 1-methylethyl, propyl, 1,1-dimethylethyl, and cyclo-propyl.

The term “aryl” refers to a phenyl, indanyl or naphthyl group. The aryl group may comprise one or more alkyl groups, and are called sometimes in this case “alkylaryl”; for example may be composed of an aromatic group and two C₁-C₆ groups (e.g. methyl or ethyl). The aryl group may also comprise one or more heteroatoms, e.g. N, O or S, and are called sometimes in this case “heteroaryl” group; these heteroaromatic rings may be fused to other aromatic systems. Such heteroaromatic rings include, but are not limited to furanyl, thienyl, pyrrolyl, pyrazolyl, imidazolyl, triazolyl, isoxazolyl, oxazolyl, thiazolyl, isothiazolyl, pyridyl, pyridazyl, pyrimidyl, pyrazinyl and triazinyl ring structures. The aryl or heteroaryl substituents may be unsubstituted or substituted with one or more substituents selected from but not limited to halogen, hydroxy, C₁-C₆ alkoxy, sulfo, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied.

Unless specifically stated otherwise, each alkyl and aryl group may be unsubstituted or substituted with one or more substituents selected from but not limited to halogen, hydroxy, sulfo, C₁-C₆ alkoxy, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied. The term “halogen” or “halo” includes fluorine, chlorine, bromine and iodine, with fluorine being preferred.

According to a preferred embodiment of the invention, the composition (C) consists of, or consists essentially of, the thermoplastic polymer, the carbon fibers and the hollow glass beads. The expression “consists essentially of” is intended to denote that the composition (C) comprises the thermoplastic polymer, the carbon fibers and the hollow glass beads, and no more than 15 wt. %, preferably no more than 10 wt. %, more preferably no more than 5 wt. %, even more preferably no more than 3 wt. %, most preferably no more than 1 wt. %, of other components.

In some embodiments the ratio of the concentration of the carbon fibers to the total concentration of the carbon fibers and the hollow glass beads ranges from 0.2 to 0.49, preferably from 0.2 to 0.48, more preferably from 0.2 to 0.45, even more preferably from 0.2 to 0.4.

In some embodiments, the ratio of the concentration of the carbon fibers to the total concentration of the carbon fibers and the hollow glass beads ranges from 0.2 to 0.49, from 0.2 to 0.48, from 0.2 to 0.45, from 0.2 to 0.4, from 0.22 to 0.49, from 0.22 to 0.48, from 0.22 to 0.45, from 0.22 to 0.4, from 0.25 to 0.49, from 0.25 to 0.48, from 0.25 to 0.45 or from 0.25 to 0.4.

Additionally, as mentioned above, the composition (C) according to the invention has good mechanical performance, in terms of tensile modulus and notably tensile strain while having a low density.

In some embodiments, the composition (C) has a tensile strain at least 1.8%, preferably of at least 1.9%, more preferably of at least 2%.

Additionally or alternatively, in some embodiments, the composition (C) has a tensile strain of no more than 4.0%, no more than 3.8%, or no more than 3.5%. In some embodiments, the composition (C) has a tensile strain ranging from 1.8% to 4.0%, from 1.8% to 3.8%, from 1.8% to 3.5%, from 1.9% to 4.0%, from 1.9% to 3.8%, from 1.9% to 3.5%, from 2.0% to 4.0%, from 2.0% to 3.8%, or from 2.0% to 3.5%.

In some embodiments, said composition (C) has a tensile modulus of at least 8 gigaPascals (“GPa”), preferably of at least 9.0 GPa, more preferably of at least 10 GPa. Additionally or alternatively, in some embodiments, said composition (C) has a tensile modulus of no more than 30 GPa, no more than 25 GPa, or no more than 20 GPa. In some embodiments, said composition (C) has a tensile modulus ranging from 8 GPa to 30 GPa, from 8 GPa to 25 GPa, from 8 GPa to 20 GPa, from 9 GPa to 30 GPa, from 9 GPa to 25 GPa, from 9 GPa to 20 GPa, from 10 to 30 GPa, from 10 GPa to 25 GPa, or from 10 GPa to 20 GPa.

In some embodiments, said composition (C) has a density expressed in g/cm³ ranging from 0.80 to 1.09, preferably from 0.83 to 1.08, more preferably from 0.85 to 1.06.

In some embodiments, said composition (C) has a density expressed in g/cm³ of no more than 1.09, or no more than 1.08 or no more than 1.06.

Additionally or alternatively, in some embodiments, said composition (C) has a density expressed in g/cm³⁰f at least 0.80 or of at least 0.83 or of at least 0.85. In some embodiments, said composition (C) has a density expressed in g/cm³ ranging from 0.80 to 1.09, from 0.80 to 1.08, from 0.80 to 1.06, from 0.83 to 1.09, from 0.83 to 1.08, from 0.83 to 1.06, from 0.85 to 1.09, from 0.85 to 1.08, or from 0.85 to 1.06.

In some embodiments, said composition (C) has a specific modulus defined as the ratio between tensile modulus (in GPa) and density (in g/cm3) of at least 8.7, preferably of at least 9.0, more preferably of at least 9.5. Additionally or alternatively, in some embodiments, said composition (C) has a specific modulus of no more than 25, no more than 20, or no more than 15. In some embodiments, said composition (C) has a tensile modulus ranging from 8.7 to 25, from 8.7 to 20, from 8.7 to 15, from 9 to 25, from 9 to 20, from 9 to 15, from 9.5 to 25, from 9.5 to 20, or from 9.5 to 15.

Tensile strain and tensile modulus can be measured as described in the Examples.

Thermoplastic Polymer

The term “thermoplastic” is intended to denote a polymer which softens on heating and hardens on cooling at room temperature, which at room temperature exists below its glass transition temperature if fully amorphous or below its melting point if semi-crystalline. It is nevertheless generally preferred for said polymer to be semi-crystalline, which is to say to have a definite melting point; preferred polymers are those possessing a heat of fusion (ΔH_{f}) of at least 10 J/g, preferably of at least 25 J/g, more preferably of at least 30 J/g, when determined according to ASTM D3418. Without upper limit for heat of fusion being critical, it is nevertheless understood that said polymer will generally possess a heat of fusion of at most 80 J/g, preferably of at most 60 J/g, more preferably of at most 40 J/g.

According to the present invention, the thermoplastic polymer is selected from the group consisting of poly(arylene sulphides) (PAS), poly(aryl ether sulfones) (PAES), poly(aryl ether ketones) (PAEK), polyesters (PE), polyamides (PA), and combinations thereof.

Poly(Arylene Suiphide) (PAS)

According to an embodiment, the thermoplastic polymer is a poly(arylene sulphide) (PAS).

As used herein, a “poly(arylene sulphide) (PAS)” comprises recurring units (R_{PAS}) of formula —(Ar—S)— as the main structural units, wherein Ar is an arylene group. The arylene group can be substituted or unsubstituted. Additionally, a poly(arylene sulphide) (PAS) can include any isomeric relationship of the sulphide linkages in the polymer; e.g., when the arylene group is a phenylene group, the sulphide linkages can be ortho, meta, para, or combinations thereof.

In some embodiments, the poly(arylene sulphide) (PAS) comprises at least 5 mol. %, at least 10 mol. %, at least 20 mol. %, at least 30 mol. %, at least 40 mol. %, at least 50 mol. %, at least 60 mol. %, at least 70 mol. %, at least 80 mol. %, at least 90 mol. %, at least 95 mol. %, at least 99 mol. %, at least 99.5 mol. %, or at least 99.9 mol. % of recurring units (R_{PAS}). As used herein, mol. % is relative to the total number of moles of recurring units in the poly(arylene sulphide) (PAS).

Preferably, the poly(arylene sulphide) (PAS) is selected from the group consisting of poly(2,4-toluene sulfide), poly(4,4′-biphenylene sulfide), poly(para-phenylene sulfide), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecylphenylene sulfide), poly(phenylphenylene sulfide), poly-(tolylphenylene sulfide), poly(benzylphenylene sulfide) and poly[octyl-4-(3-methylcyclopentyl)phenylene sulfide].

In an embodiment, the poly(arylene sulphide) (PAS) is a poly(phenylene sulphide) (PPS) and comprises recurring units (Reps) represented by formula (I):

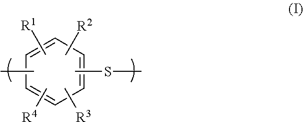

wherein R¹, R², R³, and R⁴, equal or different from each other, can be hydrogen atoms or substituents selected from the group consisting of halogen atoms, C₁-C₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups.

In its broadest definition, the poly(phenylene sulphide) (PPS) of the present invention can therefore be made of substituted and/or unsubstituted phenylene sulfide groups.

In an embodiment, the polyphenylene sulfide (PPS) comprises recurring units (R_{PPS}) represented by the following formula (II):

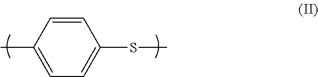

and is notably commercially available as RYTON® PPS from Solvay Specialty Polymers USA, L.L.C.

In some embodiments, the polyphenylene sulfide (PPS) comprises at least 50 mol. % of recurring units (R_{PPS}) of formula (I) and/or formula (II).

For example at least about 60 mol. %, at least about 70 mol. %, at least about 80 mol. %, at least about 90 mol. %, at least about 95 mol. %, at least about 99 mol. % of the recurring units in the polyphenylene sulfide (PPS) are recurring units (R_{PPS}) of formula (I) and/or formula (II).

According to an embodiment, the composition (C) comprises a plurality of distinct poly(arylene sulphide) polymers, each poly(arylene sulphide) polymer having a distinct recurring unit (R_{PAS}).

Poly(Aryl Ether Sufone) (PAES)

According to an embodiment, the thermoplastic polymer is a poly(aryl ether sulfone) (PAES).

As used herein, a “poly(aryl ether sulfone) (PAES)” denotes any polymer of which at least 50 mol. % of the recurring units are recurring units (R_{PAES}) of formula (III):

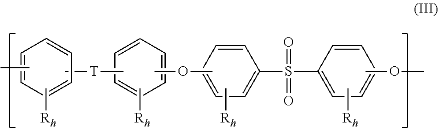

wherein:
(i) each R, equal to or different from each other, is selected from a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
(ii) each h, equal to or different from each other, is an integer ranging from 0 to 4; and
(iii) T is selected from the group consisting of a bond, a sulfone group [—S(═O)2-], and a group —C(Rj)(Rk)-, where Rj and Rk, equal to or different from each other, are selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium. Rj and Rk are preferably methyl groups.

Preferably at least 60 mol. %, 70 mol. %, 80 mol. %, 90 mol. %, 95 mol. %, 99 mol. %, and most preferably all of recurring units in the poly(aryl ether sulfone) (PAES) are recurring units (R_{PAES}) of formula (III). As used herein, mol. % is relative to the total number of moles of recurring units in the poly(aryl ether sulfone) (PAES).

In an embodiment, the poly(aryl ether sulfone) (PAES) is a poly(biphenyl ether sulfone). A poly(biphenyl ether sulfone) polymer is a poly(aryl ether sufone) which comprises a biphenyl moiety. The poly(biphenyl ether sulfone) is also known as polyphenyl sulfone (PPSU) and for example results from the condensation of 4,4′-dihydroxybiphenyl (biphenol) and 4,4′-dichlorodiphenyl sulfone.

As used herein, a “poly(biphenyl ether sulfone) (PPSU)” denotes any polymer of which more than 50 mol. % of the recurring units are recurring units (R_{PPSU}) of formula (III-A):

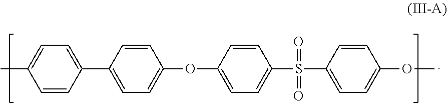

Preferably at least 60 mol. %, 70 mol. %, 80 mol. %, 90 mol. %, 95 mol. %, 99 mol. %, and most preferably all of the recurring units in the poly(biphenyl ether sulfone) (PPSU) are recurring units of formula (III-A). The poly(biphenyl ether sulfone) (PPSU) can be prepared by known methods and is notably available as RADEL® PPSU from Solvay Specialty Polymers USA, L.L.C.

In an embodiment, the poly(aryl ether sulfone) (PAES) is a polyethersulfone (PES).

As used herein, a “poly(ethersulfone) (PES)” denotes any polymer of which at least 50 mol. % of the recurring units are recurring units of formula (III-B):

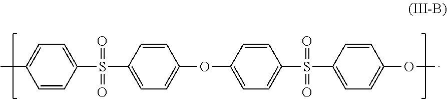

Preferably at least 60 mol. %, 70 mol. %, 80 mol. %, 90 mol. %, 95 mol. %, 99 mol. %, and most preferably all of the recurring units in the poly(ethersulfone) (PES) are recurring units of formula (III-B).

The poly(ethersulfone) (PES) can be prepared by known methods and is notably available as VERADEL® PESU from Solvay Specialty Polymers USA, L.L.C.

In an embodiment, the poly(aryl ether sulfone) (PAES) is a polysulfone (PSU).

As used herein, a “polysulfone (PSU)” denotes any polymer of which at least 50 mol. % of the recurring units are recurring units of formula (III-C):

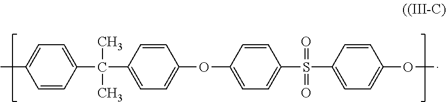

Preferably at least 60 mol. %, 70 mol. %, 80 mol. %, 90 mol. %, 95 mol. %, 99 mol. %, and most preferably all of the recurring units in the PSU are recurring units of formula (III-C).

The polysulfone (PSU) can be prepared by known methods and is available as UDEL® PSU from Solvay Specialty Polymers USA, L.L.C.

According to an embodiment, the composition (C) comprises a plurality of distinct poly(aryl ether sulfone) polymers, the poly(aryl ether sulfone) polymer being preferably selected from the group consisting of polyphenylsulfone (PPSU), poly(ethersulfone) (PES), and polysulfone (PSU).

Poly(Aryl Ether Ketone) (PAEK)

According to an embodiment, the thermoplastic polymer is poly(aryl ether ketone) (PAEK).

As used herein, a “poly(aryl ether ketone) (PAEK)” denotes any polymer comprising more than 50 mol % of recurring units (R_{PAEK}), wherein recurring units (R_{PAEK}) comprise a Ar—C(O)—Ar′ group, wherein Ar and Ar′, equal to or different from each other, are aromatic groups.

In some embodiments, the poly(aryl ether ketone) (PAEK) comprises at least 60 mol. %, at least 70 mol. %, at least 80 mol. %, at least 90 mol. %, at least 95 mol. %, or at least 99 mol. %, at least 99.5 mol %, or at least 99.9 mol % of recurring units (R_{PAEK}). As used herein, mol. % is relative to the total number of moles of recurring units in the poly(aryl ether ketone) (PAEK).

In some embodiments, the recurring units (R_{PAEK}) are selected from the group consisting of formulae (J-A) to (J-O), herein below:

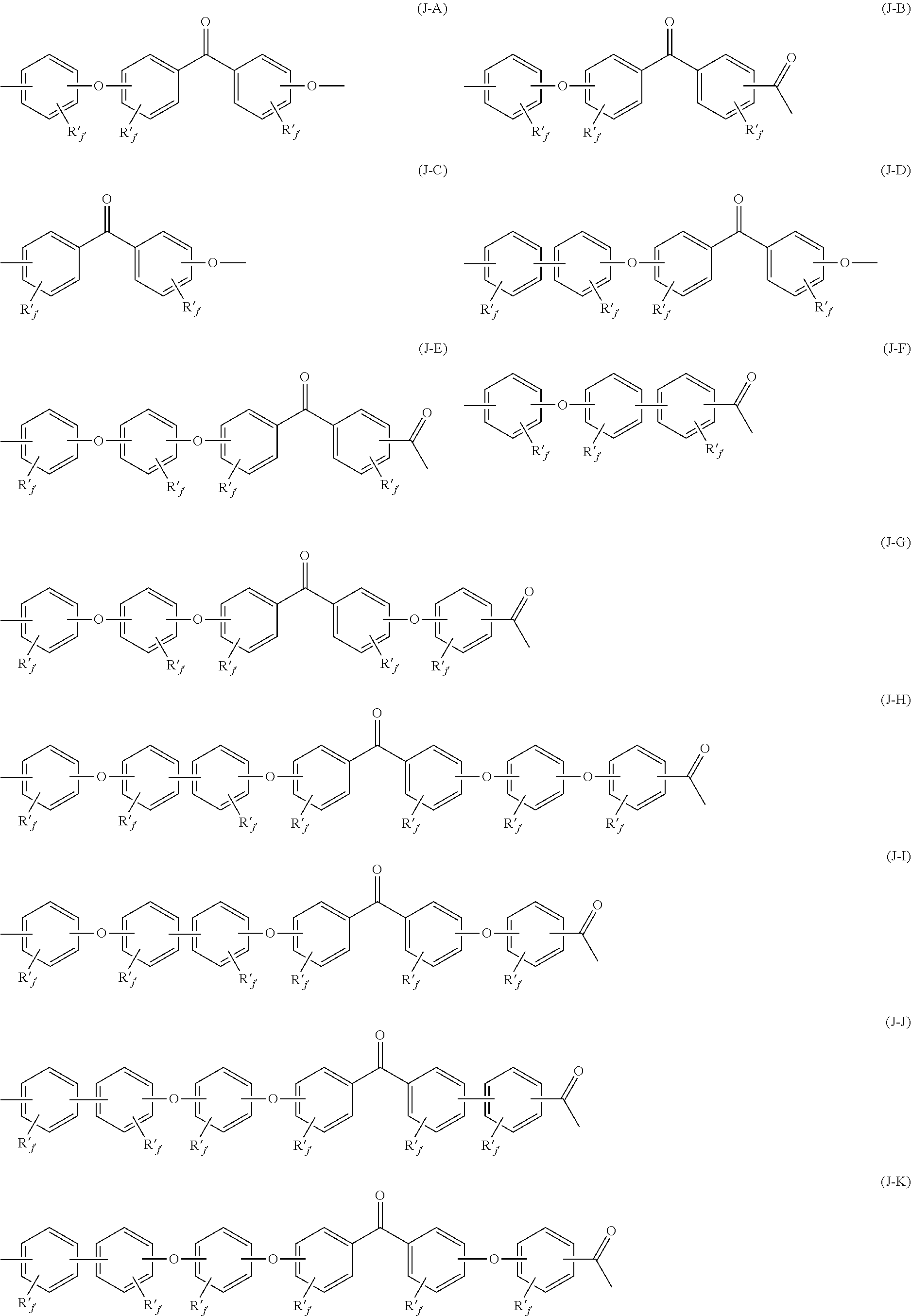

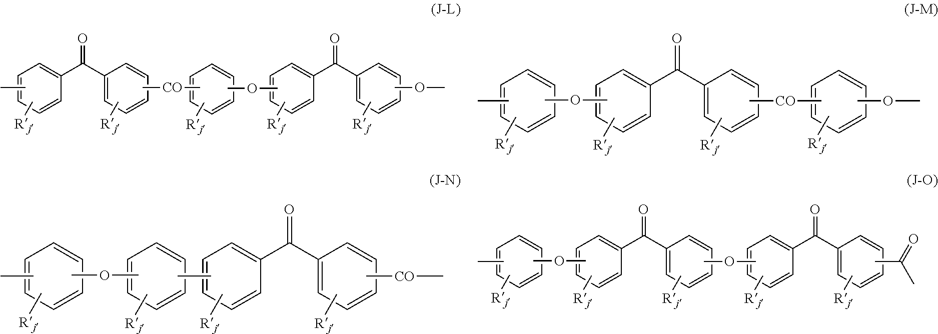

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′ is an integer from 0 to 4.

In recurring unit (R_{PAEK}), the respective phenylene moieties may independently have 1,2-, 1,4- or 1,3-linkages to the other moieties different from R′ in the recurring unit. Preferably, the phenylene moieties have 1,3- or 1,4-linkages, more preferably they have 1,4-linkage.

In some embodiments, j′ in recurring unit (R_{PAEK}) is at each occurrence zero. That is to say that the phenylene moieties have no other substituents than those enabling linkage in the main chain of the polymer.

Preferred recurring units (R_{PAEK}) are thus selected from those of formulae (J′-A) to (J′-0) herein below:

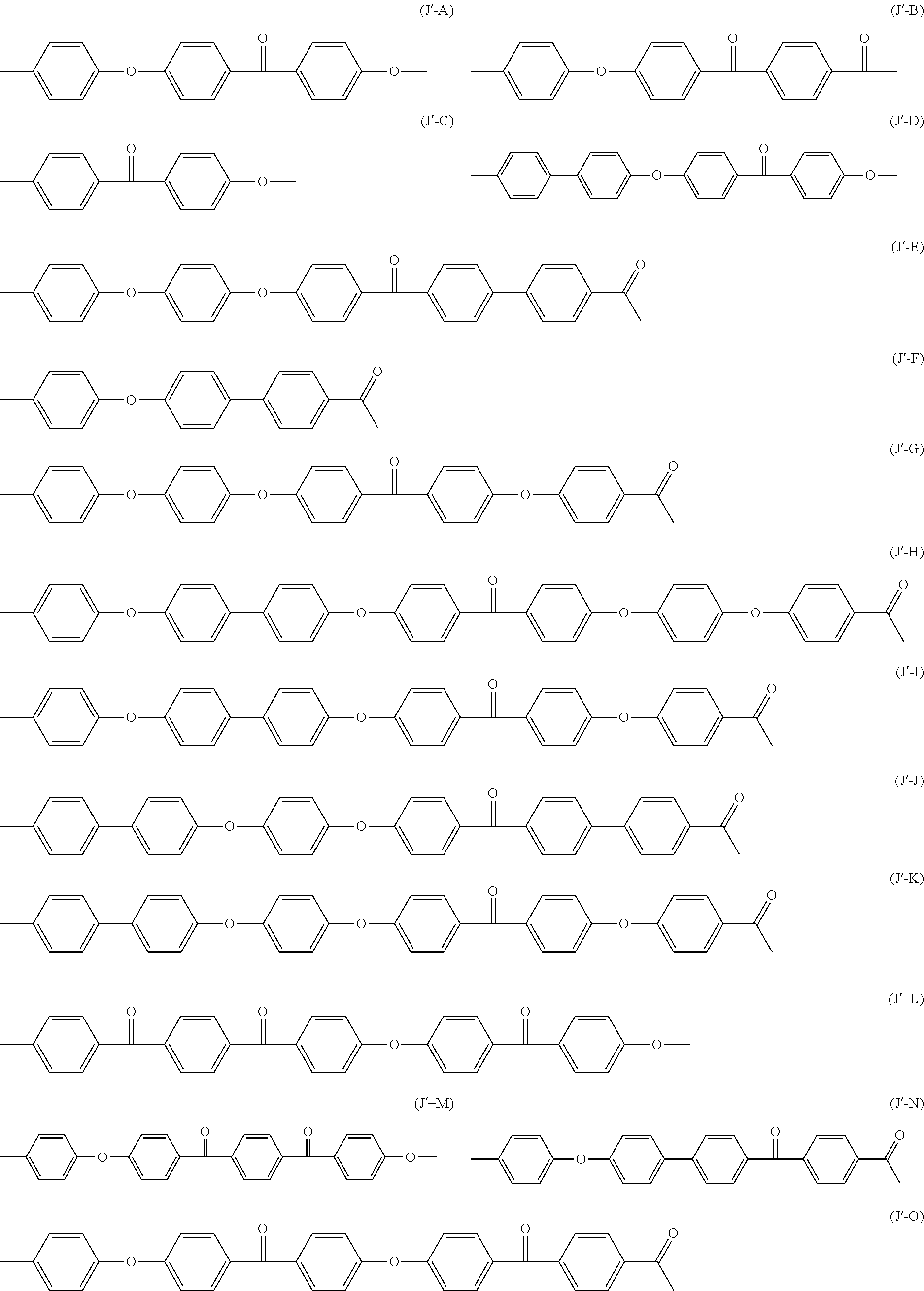

In a preferred embodiment, the polyaryletherketone (PAEK) is a polyetheretherketone (PEEK). In this embodiment, the polyetheretherketone (PEEK) has recurring units (R_{PEEK}) represented by either formula (J-A) or (J′-A), preferably recurring unit (R_{PEEK}) is represented by formula (J′-A).

According to an embodiment, the composition (C) comprises a plurality of distinct poly(aryl ether ketone) polymers, each poly(aryl ether ketone) polymer having a distinct recurring unit (R_{PAEK}).

Polyester (PE)

According to an embodiment, the thermoplastic polymer is a polyester (PE).

As used herein, a “polyester (PE)” denotes a polymer comprising at least 50 mol. %, preferably at least 85 mol. % of recurring units comprising at least one ester moiety (commonly described by the formula: R—(C═O)— OR′). Polyesters (PE) may be obtained by ring opening polymerization of a cyclic monomer (M_{A}) comprising at least one ester moiety; by polycondensation of a monomer (M_{B}) comprising at least one hydroxyl group and at least one carboxylic acid group, or by polycondensation of at least one monomer (M_{C}) comprising at least two hydroxyl groups (a diol) and at least one monomer (M_{D}) comprising at least two carboxylic acid groups (a dicarboxylic acid). As used herein, the term dicarboxylic acid is intended to include dicarboxylic acids and any derivative of dicarboxylic acids, including their associated acid halides, esters, half-esters, salts, half-salts, anhydrides, mixed anhydrides, or mixtures thereof.

In an embodiment, the polyester (PE) is selected from the group consisting of aromatic polyesters and polyalkylene esters. Examples of aromatic polyesters include poly(isophthalate-terephthalate-resorcinol) esters, poly(isophthalate-terephthalate-bisphenol A) esters, poly[(isophthalate-terephthalate-resorcinol)ester-co-(isophthalate-terephthalate-bisphenol A)]esters, and combinations thereof.

Polyalkylene esters include polyalkylene arylates, for example polyalkylene terephthalates and polyalkylene naphthalates. Examples of polyalkylene terephthalates include polyethylene terephthalate (PET), polybutylene terephthalate (PBT), and polypropylene terephthalate (PPT). Examples of polyalkylene naphthalates include polyethylene naphthalate (PEN), and polybutylene naphthalate (PBN).

In an embodiment, the polyester (PE) comprises at least 50 mol. %, preferably at least 60 mol. %, more preferably at least 70 mol. %, still more preferably at least 80 mol. %, most preferably at least 90 mol. %, of recurring units comprising, in addition to the at least one ester moiety, at least one cycloaliphatic group. In an embodiment, the polyester (PE) is essentially composed of recurring units comprising at least one ester moiety and at least one cycloaliphatic group. The cycloaliphatic group may derive from monomers (M_{A}), monomers (M_{B}), monomers (M_{C}) or monomers (M_{D}) comprising at least one group which is both aliphatic and cyclic.

Non limitative examples of monomers (M_{A}) include lactide and caprolactone. Non limitative examples of monomers (M_{B}) include glycolic acid, 4-hydroxybenzoic acid and 6-hydroxynaphthalene-2-carboxylic acid. Non limitative examples of monomers (M_{C}) include 1,4-cyclohexanedimethanol, ethylene glycol, 1,2-propanediol, 1,3-propanediol, 1,4-butanediol, 1,5-pentanediol, 1,6-hexanediol, 1,8-octanediol, 1,10-decanediol, 2,2,4-trimethyl 1,3-pentanediol, 2,2,4,4-tetramethyl-1,3-cyclobutanediol, and neopentyl glycol, while 1,4-cyclohexanedimethanol and neopentyl glycol are preferred. Non limitative examples of monomers (M_{D}) include terephthalic acid, isophthalic acid, naphthalene dicarboxylic acids, 1,4-cyclohexane dicarboxylic acid, succinic acid, sebacic acid, and adipic acid, while terephthalic acid and 1,4-cyclohexane dicarboxylic acid are preferred.

When the polyester (PE) is a copolymer, monomers (M_{C}) and (M_{D}) are preferably used. In such a case, monomer (M_{C}) is preferably 1,4-cyclohexanedimethanol and monomer (M_{D}) is preferably a mixture of terephthalic acid and 1,6-naphthalene dicarboxylic acid.

When the polyester (PE) is a homopolymer, it may be selected from poly(cyclohexylenedimethylene terephthalate) (PCT) and poly(cyclohexylenedimethylene naphthalate) (PCN). According to an embodiment, the composition (C) comprises a plurality of distinct polyesters.

Polyamide (PA)

According to an embodiment, the thermoplastic polymer is a polyamide (PA).

As used herein, a “polyamide (PA)” comprises recurring units (R_{PA}) comprising amide bonds, which are typically derived from the polycondensation of at least one dicarboxylic acid component (or derivative thereof) and at least one diamine component, and/or from the polycondensation of aminocarboxylic acids and/or lactams.

The expression “derivative thereof” when used in combination with the expression “carboxylic acid” is intended to denote whichever derivative which is susceptible of reacting in polycondensation conditions to yield an amide bond, such as acyl groups.

Preferably, the polyamide (PA) is selected from the group consisting of aliphatic, cycloaliphatic and semi-aromatic polyamides. According to preferred embodiment, the thermoplastic polymer is an aliphatic polyamide.

As used herein, an aliphatic polyamide includes at least 50 mol % of a recurring unit R_{PA}, which has an amide bond (—NH—CO—) and is free of any aromatic and cycloaliphatic groups. Put another way, both the diamine and diacid forming, through polycondensation, recurring units (R_{PA}) are free of any aromatic and cycloaliphatic groups. In some embodiments, said aliphatic polyamide has at least 60 mol %, at least 70 mol %, at least 80 mol %, at least 90 mol %, at least 95 mol %, at least 95 mol %, at least 99 mol %, or at least 99.9 mol % of recurring unit (R_{PA}).

Preferably, the recurring unit (R_{PA}) is represented by the following formula (IV):

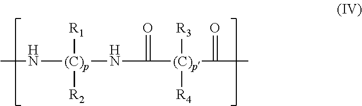

wherein:

R₁ to R₄, at each location, is independently selected from the group consisting of a hydrogen, an alkyl, an aryl, an alkali or alkaline earth metal sulfonate, an alkyl sulfonate, and a quaternary ammonium;

p is an integer from 4 to 10;

and p′ is an integer from 4 to 18.

Preferably, R₁ to R₄, at each location, is a hydrogen. Preferably, p is 4 to 6. Preferably, p′ is 6 to 12. Preferably, said aliphatic polyamide is selected from the group consisting of PA 4,6; PA 5,6; PA 5,9; PA 5,10; PA 6,9; PA 6,10; PA 10,10; and PA 10,12. More preferably, said aliphatic polyamide is selected from PA 5, 10; PA 6,10 and PA 10,10. Preferably, said aliphatic polyamide has an inherent viscosity of 0.7 to 1.4 deciliters/g (“dL/g”), as measured according to ASTM D5336.

According to an embodiment, the composition (C) includes a plurality of distinct aliphatic polyamides according to the above description, each aliphatic polyamide having a distinct recurring unit R_{PA}.

According to an embodiment, the composition (C) includes a plurality of distinct thermoplastic polymers. Preferably, at least one of said distinct thermoplastic polymers is selected from the group consisting of aliphatic, cycloaliphatic and semi-aromatic polyamides. Even more preferably, at least one of said distinct thermoplastic polymers is an aliphatic polyamide.

According to an embodiment, the composition (C) includes one polyamide or a plurality of distinct polyamides, preferably one aliphatic polyamide or a plurality of distinct aliphatic polyamides, and do not include any other thermoplastic polymer.

The composition (C) comprises said thermoplastic polymer or said plurality of distinct thermoplastic polymers in a concentration of 10-82 wt. %, preferably from 40 to 82 wt. %, more preferably from 45 to 75 wt. %, even more preferably from 50 to 70 wt. %, based on the total weight of the composition (C).

In some embodiments, the composition (C) comprises said thermoplastic polymer or said plurality of distinct thermoplastic polymers in a concentration of at least 40 wt. %, at least 45 wt. %, or at least 50 wt. %, with respect to the total weight of the composition (C). Additionally or alternatively, in some embodiments, the composition (C) comprises said thermoplastic polymer or said plurality of distinct thermoplastic polymers in a concentration of at most 82 wt. %, at most 75 wt. %, or at most 70 wt. %, with respect to the total weight of the composition (C). In some embodiments, the concentration of said thermoplastic polymer or said plurality of distinct thermoplastic polymers is from 40 wt. % to 82 wt. %, from 40 wt. % to 75 wt. %, from 40 wt. % to 70 wt. %, from 45 wt. % to 82 wt. %, from 45 wt. % to 75 wt. %, from 45 wt. % to 70 wt. %, from 50 wt. % to 82 wt. %, from 50 wt. % to 75 wt. %, from 50 wt. % to 70 wt. %, with respect to the total weight of the composition (C).

The Carbon Fiber

The polymer composition includes carbon fibers

While the morphology of the carbon fibers is not particularly limited, in some embodiments, the carbon fibers are chopped carbon fibers and have preferably an average cut length of 4 mm to 10 mm, or more preferably from 4.5 to 8 mm. Additionally or alternatively, in some embodiments, the carbon fibers have an average aspect ratio (longest length/longest diameter) of 20 to 40, where the diameter is perpendicular to the length.

In some embodiments, the carbon fibers can have a tow of 12,000 to 50,000.

The composition (C) comprises carbon fibers in a concentration of from 5 wt. % to 45 wt. % with respect to the total weight of the composition (C) or preferably from 5 to 30 wt. %, or more preferably preferably from 8 to 25 wt. %, or even more preferably from 10 to 20 wt. %.

In some embodiments, the composition (C) comprises said carbon fibers in a concentration of at least 5 wt. %, at least 8 wt. %, or at least 10 wt. %, with respect to the total weight of the composition (C).

Additionally or alternatively, in some embodiments, the composition (C) comprises said carbon fibers in a concentration of at most 30 wt. %, at most 25 wt. %, or at most 20 wt. %, with respect to the total weight of the composition (C).

In some embodiments, the concentration of said carbon fibers is from 5 wt. % to 30 wt. %, from 5 wt. % to 25 wt. %, from 5 wt. % to 20 wt. %, from 8 wt. % to 30 wt. %, from 8 wt. % to 25 wt. %, from 8 wt. % to 20 wt. %, from 10 wt. % to 30 wt. %, from 10 wt. % to 25 wt. %, from 10 wt. % to 20 wt. %, with respect to the total weight of the composition (C).

Hollow Glass Beads

Hollow glass beads (also known as hollow glass microspheres or bubbles) are well known and notably are mentioned in Plastics Additives Handbook, Hanser, 4th edition, pages 537-538.

In some embodiments, the hollow glass beads included in the composition (C) has a crush strength of at least 10,000 psi, at least 13,000 psi, at least 15,000 psi, or at least 16,000 psi, or at least 18,000 psi, or at least 20,000 psi, or at least 30,000 psi. The crush strength can be measured according to ASTM D 3102-72. Preferably, the hollow glass beads have a crush strength of at least 15,000 psi.

In some embodiments, the hollow glass beads included in the composition (C) have a number average diameter of from 5 to 50 μm, from 10 to 40 μm, from 15 to 30 μm. The average diameter can be measured by microscopy, preferably scanning electron microscopy (SEM).

In some embodiments, the hollow glass beads included in the composition (C) have a density of from 0.2 to 1.5 g/cm³, from 0.2 to 1.2 g/cm³, from 0.25 to 1.0 g/cm³, from 0.3 to 0.9 g/cm³, from 0.35 to 0.7 g/cm³, from 0.4 to 0.6 g/cm³. The density can be measured according to ASTM D 2840-69.

The composition (C) comprises the hollow glass beads in a concentration of from 13 wt. % to 45 wt. % with respect to the total weight of the composition (C). In some preferred embodiments, the composition (C) comprises said hollow glass beads in a concentration of 13 wt. % to 40 wt. % or 13 wt. % to 35 wt. % or 13 wt. % to 30 wt. % or 15 wt. % to 30 wt. % with respect to the total weight of the composition (C).

Other Reinforcing Additives

Although not preferred, the composition (C) according to the invention may comprise other types of reinforcing additives such as reinforcing fibers, for examples glass fibers or polymer fibers. The addition of dielectric fibers may have for example an effect in reducing the conductivity of the composition. When present such additives may be included at a level of from 0 to 15 wt. %, or from 0 to 5 wt. % or from 0.5 to 3 wt. %.

Optional Additives

In some embodiments, the composition (C) according to the invention includes one or more additives selected from the group consisting of ultra-violet (“UV”) stabilizers, heat stabilizers, pigments, dyes, flame retardants, impact modifiers, lubricants and any combination of one or more thereof.

In some embodiments in which the composition (C) includes optional additives, the total concentration of additives is no more than 15 wt. %, no more than 10 wt. %, no more than 5 wt. %, no more than 1 wt. %, no more 0.5 wt. %, no more than 0.4 wt. %, no more than 0.3 wt. %, no more than 0.2 wt. %, or no more than 0.1 wt. %.

Method

The composition (C) according to the invention can be made using methods well known in the art.

For example, in an embodiment, the composition (C) is made by melt-blending the thermoplastic polymer, the carbon fibers, the hollow glass beads, and any optional additives. Any suitable melt-blending method may be used for combining the components of the composition (C).

For example, in an embodiment, all of the components of the composition (C) (i.e. the thermoplastic polymer, the carbon fibers, the hollow glass beads, and any optional additives) are fed into a melt mixer, such as single screw extruder or twin screw extruder, agitator, single screw or twin screw kneader, or Banbury mixer. The components can be added to the melt mixer all at once or gradually in batches. When said components are gradually added in batches, a part of the components is first added and then is melt-mixed with the remaining part of the components, which are subsequently added, until an adequately mixed composition is obtained.

If the carbon fibers used present a long physical shape (for example, a carbon fibers having as average length of from 4 to 10 mm), drawing extrusion molding may be used to prepare a reinforced composition.

Mobile Electronic Device

Due to its surprisingly good mechanical performance, the composition (C) according to the description above can be desirably integrated into mobile electronic device components.

The term “mobile electronic device” is intended to denote an electronic device that is designed to be conveniently transported and used in various locations. Representative examples of mobile electronic devices may be selected from the group consisting of mobile electronic phones, personal digital assistants, laptop computers, tablet computers, radios, cameras and camera accessories, watches, calculators, music players, global positioning system receivers, portable games & headsets, hard drives and other electronic storage devices. Preferred mobile electronic devices include laptop computers, tablet computers, mobile electronic phones and watches.

Components of mobile electronic devices of interest herein include, but are not limited to, fitting parts, snap fit parts, mutually moveable parts, functional elements, operating elements, tracking elements, adjustment elements, carrier elements, frame elements, switches, connectors, cables, antenna splits, housings, and any other structural part other than housings as used in mobile electronic devices, such as for example speaker parts. Said mobile electronic device components can be notably produced by injection molding, extrusion or other shaping technologies.

A “mobile electronic device housing” refers to one or more of the back cover, front cover, antenna housing, frame and/or backbone of a mobile electronic device. The housing may be a single article or comprise two or more components. A “backbone” refers to a structural component onto which other components of the device, such as electronics, microprocessors, screens, keyboards and keypads, antennas, battery sockets, and the like are mounted. The backbone may be an interior component that is not visible or only partially visible from the exterior of the mobile electronic device. The housing may provide protection for internal components of the device from impact and contamination and/or damage from environmental agents (such as liquids, dust, and the like). Housing components such as covers may also provide substantial or primary structural support for and protection against impact of certain components having exposure to the exterior of the device such as screens and/or antennas.

In a preferred embodiment, the mobile electronic device housing is selected from the group consisting of a mobile phone housing, an antenna housing, a tablet housing, a laptop computer housing, a tablet computer housing or a watch housing.

The mobile electronic device components can be made from the composition using any suitable melt-processing method. For example, the mobile electronic device components can be made by injection molding or extrusion molding the polymer composition. Injection molding is a preferred method.

The invention will now be described with reference to the following examples, whose purpose is merely illustrative and not intended to limit the scope of the invention.

### Experimental Section

Test Specimens

Test specimens E1-E6 in accordance with the invention and comparative test specimens C1-C6 were prepared were prepared as detailed below.

Materials Used

Radipol® DC40 is a PA 6,10 (aliphatic polyamide polymer) commercially obtained from Radici.

Chopped carbon fibers with PU sizing and cut length of about 6 mm from Tenax or Apply Carbon.

iM160K hollow glass beads having a crush strength of 16,000 psi commercially obtained from 3M.

Calcium stearate lubricant commercially obtained from BASF.

Irganox® 1098 heat stabilizer commercially obtained from BASF.

Methods

Compounding Mixtures containing Radipol® DC40, carbon fibers, hollow glass beads iM16K, calcium stearate and Irganox® were melt-blended in the amounts set in Table 1 below using a Coperion® ZSK-26 co-rotating twin-screw extruder (with an L/D ratio of 48:1, at 200 rpm and 13-18 kg/hr, and with barrel temperature set points of 280° C. and die temperature set points of 245° C.) and subsequently molded according to ASTM D3641 at a melt temperature of 240° C. to 260° C. and mold temperature of 90° C. to 120° C. to form.

Testing

Tensile modulus, and tensile strain were measured according to ASTM D638. Measurements were made on 5 injection molded ASTM tensile bars and were characterized using a 2 mm/minute for the whole test. The ASTM tensile bar had a length of 50.08±0.5 mm, a width of 12.7±0.5 mm, and a thickness of 3.2±0.4 mm.

Specific gravity and density was measured according to ASTM D792A on a molded sample having the dimensions of an ASTM flex bar 3.2±0.4 mm by 12.7±0.5 mm by 125±0.5 mm.

All tensile and density measurements were performed at room temperature. Prior to measurements, samples were conditioned according to ASTM D618.

Results

Table 1 shows the components and the amounts thereof contained in the test specimens.

TABLE 1

| | Thermo- | | | Additives |
|---|---|---|---|---|
| | plastic | | Hollow | Calcium |
| | polymer | | glass | stearate/ |
| | Radipol ® | | bead | Irganox ® |
| | DC40 | Carbon | iM16K | 1098 |
| | [wt. %] | fiber | [wt. %] | [wt. %] |
| C1 | 89.7 | 0 | 10 | 0.3 |
| C2 | 79.7 | 10 | 10 | 0.3 |
| C3 | 74.7 | 15 | 10 | 0.3 |
| C4 | 79.7 | 0 | 20 | 0.3 |
| E1 | 69.7 | 10 | 20 | 0.3 |
| E2 | 64.7 | 15 | 20 | 0.3 |
| C5 | 74.7 | 0 | 25 | 0.3 |
| E3 | 64.7 | 10 | 25 | 0.3 |
| E4 | 59.7 | 15 | 25 | 0.3 |
| C6 | 69.7 | 0 | 30 | 0.3 |
| E5 | 59.7 | 10 | 30 | 0.3 |
| E6 | 54.7 | 15 | 30 | 0.3 |

Table 2 shows the performance results of test specimens

TABLE 2

| | Tensile | Tensile | | Specific |
|---|---|---|---|---|
| | modulus | Strain | Density | Modulus |
| | GPa | % | g/cm³ | GPacm³/g |
| C1 | 3.1 | 7.0 | 0.96 | 3.23 |
| C2 | 9.0 | 3.8 | 1.05 | 8.57 |
| C3 | 12.6 | 3.2 | 1.09 | 11.56 |
| C4 | 3.4 | 1.8 | 0.91 | 3.74 |
| E1 | 8.9 | 2.5 | 0.99 | 8.99 |
| E2 | 12.2 | 2.3 | 1.05 | 11.62 |
| C5 | 3.5 | 1.5 | 0.88 | 3.98 |
| E3 | 9.1 | 2.5 | 0.97 | 9.38 |
| E4 | 12.7 | 2.4 | 1.03 | 12.33 |
| C6 | 3.7 | 1.4 | 0.85 | 4.35 |
| E5 | 10.3 | 2 | 0.97 | 10.62 |
| E6 | 14.4 | 1.9 | 1.05 | 13.71 |

As evident from the results presented in Table 2, test specimens E1-E6 provide for a desirable combination of low density and good mechanical properties. For a given amount of hollow glass beads, examples according to the invention have a better combination of Tensile Strain and Tensile Modulus than comparative example at the expense of a small increase in density due to the carbon fibers. Comparative examples with the same density have lower tensile modulus and tensile strain than examples according to the invention. The advantages provided by composition according to the present invention are evidenced in particular by considering the parameter “specific modulus” i.e. the ratio between tensile modulus and density. As it can be seen from the data in Table 2 all the examples according to the invention have a specific modulus higher than 8.6 while all the comparative examples have a specific modulus of less than 8.6, with the exception of example C3 which has however a very high density of 1.09 g/cm³, and is therefore less suitable as “light” material than the materials of the inventive examples which all have a density of 1.05 g/cm³ or below.

Additionally the data reported in Table 2 also indicated that, as expected, the tensile strain, decreases linearly with increasing the carbon fibers content of a composition containing 10 wt. % of hollow glass beads (see examples C1, C2 and C3. Unexpectedly in samples according to the invention (see E1 and E2 vs. C4, E3 and E4 vs. C5, E5 and E6 vs. C6) the tensile strain increases up to a plateau while increasing the concentration of carbon fibers. Therefore the combination of properties of the inventive examples and in particular their high tensile strain is unexpected considering the effect of carbon fibers in compositions outside the claimed scope.

The embodiments above are intended to be illustrative and not limiting. Additional embodiments are within the inventive concepts. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

1. A polymer composition [composition (C)] comprising:
10-82% by weight of at least one thermoplastic polymer selected from the group consisting of poly(arylene sulphide) (PAS), poly(aryl ether sulfone) (PAES), poly(aryl ether ketone) (PAEK), polyesters (PE), polyamides (PA), and combinations thereof;
5-45% by weight of carbon fibers; and
13-45% by weight of hollow glass beads.

2. The composition (C) according to claim 1, wherein the ratio of the concentration of the carbon fibers to the total concentration of the carbon fibers and the hollow glass beads ranges from 0.2 to 0.49.

3. The composition (C) according to claim 1, wherein the thermoplastic polymer is selected from the group consisting of aliphatic, cycloaliphatic and semi-aromatic polyamides.

4. The composition (C) according to claim 3, wherein the polyamide comprises recurring units R_{PA} represented by the following formula (IV): 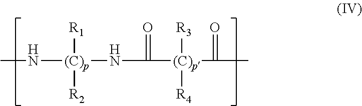
wherein:
R₁ to R₄, at each location, is independently selected from the group consisting of a hydrogen, an alkyl, an aryl, an alkali or alkaline earth metal sulfonate, an alkyl sulfonate, and a quaternary ammonium;
p is an integer from 4 to 10; and
p′ is an integer from 4 to 18.

5. The composition (C) according to claim 4, wherein the polyamide is selected from the group consisting of PA 4,6; PA 5,6; PA 5,9; PA 5,10; PA 6,9; PA 6,10; PA 10,10; and PA 10,12.

6. The composition (C) according to claim 1, wherein the carbon fibers are chopped carbon fibers having a cut length of from 4 to 10 mm.

7. The composition (C) according to claim 1, wherein the hollow glass beads have a crush strength of at least 10,000 psi.

8. The composition (C) according to claim 1, comprising the hollow glass beads in a concentration from 13 to 40 wt. % based on the total weight of the composition (C).

9. The composition (C) according to claim 1, comprising the carbon fibers in a concentration from 5 to 30 wt. %, based on the total weight of the composition (C).

10. The composition (C) according to claim 1, comprising the thermoplastic polymer in a concentration from 40 to 82 wt. % based on the total weight of the composition (C).

11. The composition (C) according to claim 1, wherein the composition has a tensile strain of at least 1.8%.

12. The composition (C) according to claim 1, wherein the composition has a tensile modulus of at least 8 GPa.

13. The composition (C) according to claim 1, wherein the composition has a density expressed in g/cm³ ranging from 0.80 to 1.09.

14. The composition (C) according to claim 1, wherein the composition has a ratio between a tensile modulus (in GPa) of the composition and a density (in g/cm3) of the composition of at least 8.7.

15. A mobile electronic device component comprising the composition (C) according to claim 1, wherein the mobile electronic device component is a mobile electronic device housing.
